(19) United States
(12) Patent Application Publication
(10) Pub. No.: US 2025/0392888 A1
(43) Pub. Date: Dec. 25, 2025

(54) LEVERAGING AN EMBEDDED SUBSCRIBER IDENTITY MODULE AND SENSOR DATA FOR NEAR REAL-TIME EVENT DETECTION AND ALERTING

(71) Applicant: T-MOBILE INNOVATIONS LLC, Overland Park, KS (US)

(72) Inventor: Surajit CHATTARAJ, Maple Valley, WA (US)

(21) Appl. No.: 18/750,356

(22) Filed: Jun. 21, 2024

(51) Int. Cl. H04W 4/38; H04W 4/90; H04W 24/02

(52) U.S. Cl. CPC H04W 4/38; H04W 4/90; H04W 24/02

(57) ABSTRACT

Aspects herein capture methods, media, devices, and systems for a device having an embedded Subscriber Identity Module (eSIM), wherein the device can leverage sensors, networks, and machine learning capabilities to identify a behavioral pattern of a user of the device and to identify a deviation from that pattern based on a qualifying event. Based on identifying a deviation from that pattern, the device may initiate an action based on that deviation, and the action may include communicating an alert that the deviation might be associated with a hazardous condition or event. The device may alert a user of the hazardous condition or event by communicating the alert in a mode that is sensible to the user, based on the user preferences that define the accessibility setting that is specific to the physical characteristics of the user. Such modes may include audible, haptic, or optical presentations of the alert.

### TECHNICAL BACKGOUND

The present disclosure generally relates to telecommunication networks.

### SUMMARY

A high-level overview of various aspects of the disclosure is provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

In one aspect, a computerized method is provided. In accordance with the method, data captured in near real-time by a device and having an embedded Subscriber Identity Module (eSIM) is monitored. A pattern in the data captured is identified using a machine learning model. Based on subsequently monitoring additional data captured in near real-time by the device, a deviation from the pattern identified using the machine learning model is detected in the additional data. Whether the deviation meets or exceeds a threshold is determined. When the deviation is determined to exceed the threshold, an action is initiated. Then, an event associated with the deviation is identified.

In another aspect, one or more non-transitory computer-readable media storing instructions are provided that, when executed via one or more processors, perform a computerized method. In accordance with the media, data captured in near real-time by a device having an embedded Subscriber Identity Module (eSIM) is monitored. A pattern in the data captured is identified using a machine learning model. Based on subsequently monitoring additional data captured in near real-time by the device, a deviation in the additional data from the pattern identified using the machine learning model is detected. Whether the deviation meets or exceeds a threshold is determined. When the deviation is determined to exceed the threshold, an action is initiated. Then, an event associated with the deviation is identified.

In yet another aspect, a system is provided. The system comprises a user device having one or more processors, and an embedded Subscriber Identity Module (eSIM) operating within a telecommunications network. A device having the eSIM is configured to receive data captured in near real-time as input data. The eSIM is configured to, using a machine learning model, identify a pattern in the data captured. Based on subsequently monitoring additional data captured in near real-time by the device, the eSIM detects a deviation in the additional data from the pattern identified using the machine learning model. The eSIM determines whether the deviation meets or exceeds a threshold. The eSIM is configured to, when the deviation is determined to exceed the threshold, initiate an action. The eSIM is configured to identify an event associated with the deviation. The eSIM is configured to generate and communicate an alert to the user device.

### BRIEF DESCRIPTION OF THE DRAWINGS

Aspects are described in detail below with reference to the attached figures, wherein:

FIG. 1 depicts an example of a system environment in accordance with aspects;

FIG. 2 is a flowchart for an example method in accordance with aspects; and

FIG. 3 is an example device suitable for use in implementations of the disclosure.

### DETAILED DESCRIPTION

The subject matter of the present disclosure is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present disclosure can be embodied in many different forms and should not be construed as limited to the aspects set forth herein.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present disclosure. The following is a list of these acronyms:
3G Third-Generation Wireless Access Technology
4G Fourth-Generation Wireless Access Technology
5G/5G NR Fifth-Generation Wireless Access Technology/New Radio
5GC Fifth-Generation Wireless Access Technology Core Network
AAU Active Antenna Unit
BRS Broadband Radio Service
CD-ROM Compact Disk Read Only Memory
CDMA Code Division Multiple Access
CU Central Unit
DU Distribution Unit
EIRP Equivalent Isotropically Radiated Power
eNodeB Evolved Node B
EVDO Evolution-Data Optimized
GIS Geographic/Geographical/Geospatial Information System
gNodeB/gNB Next Generation Node B
gNB CU Next Generation Node B Central Unit
gNB DU Next Generation Node B Distribution Unit
GPRS General Packet Radio Service
GSM Global System for Mobile Communication
iDEN Integrated Digital Enhanced Network
DVD Digital Versatile Disc
EEPROM Electrically Erasable Programmable Read-Only Memory
FD-MIMO Full Dimension Multiple-Input Multiple-Output
IOT Internet of Things
IIOT Industry Internet of Things
LED Light Emitting Diode
LTE Long Term Evolution
MEC Mobile Far Edge Computer
MD Mobile Device
MIMO Multiple-Input Multiple-Output
mMIMO Massive Multiple-Input Multiple-Output
MMU Massive Multiple-Input Multiple-Output Unit
mmWave Millimeter Wave
NEXRAD Next-Generation Radar
NR New Radio
OOBE Out-of-Band-Emission
OTN Optical Transport Network
PC Personal Computer
PCS Personal Communications Service
PDA Personal Digital Assistant
PLMN Public Land Mobile Network
PRB Physical Resource Block
vPRB Virtualized Physical Resource Block
RAN Radio Access Network
RAM Random Access Memory
RET Remote Electrical Tilt
RF Radio-Frequency
RFI Radio-Frequency Interference
RIC Radio Intelligent Controller
RLF Radio Link Failure
R/N Relay Node
RNR Reverse Noise Rise
ROM Read-Only Memory
RRU Remote Radio Unit
RSRP Reference Signal Receive Power
RSRQ Reference Signal Receive Quality
RSSI Received Signal Strength Indicator
RU Radio Unit
SINR Signal-to-Interference-&-Noise Ratio
SNR Signal-to-Noise Ratio
SON Self-Organizing Networks
TDMA Time Division Multiple Access
TXRU Transceiver (or Transceiver Unit)
UE User Equipment
UMTS Universal Mobile Telecommunications System
UTRAN UMTS Radio Access Network
E-UTRAN Evolved Universal Mobile Telecommunications System
WCD Wireless Communication Device (interchangeable with UE)
WLAN Wireless Local Area Network
XR Extended Reality

Further, various technical terms are used throughout this description. An illustrative resource that fleshes out various aspects of these terms can be found in Newton's Telecom Dictionary, 25th Edition (2009).

Aspects herein may be embodied as, among other things: a method, system, or set of instructions embodied on one or more computer-readable media. Aspects may take the form of a hardware aspect or an aspect combining software and hardware. Some aspects may take the form of a computer program product that includes computer-useable or computer-executable instructions embodied on one or more computer-readable media.

### Definitions

“Computer-readable media” can be any available media and may include volatile and non-volatile media, as well as removable and non-removable media. By way of example, and not limitation, computer-readable media may include computer storage media and communication media. Computer-readable media may include both volatile and non-volatile media, removable and non-removable media, and may include media readable by a database, a switch, and various other network devices. Computer-readable media includes media implemented in any way for storing information. Examples of stored information include computer-useable instructions, data structures, program modules, and other data representations.

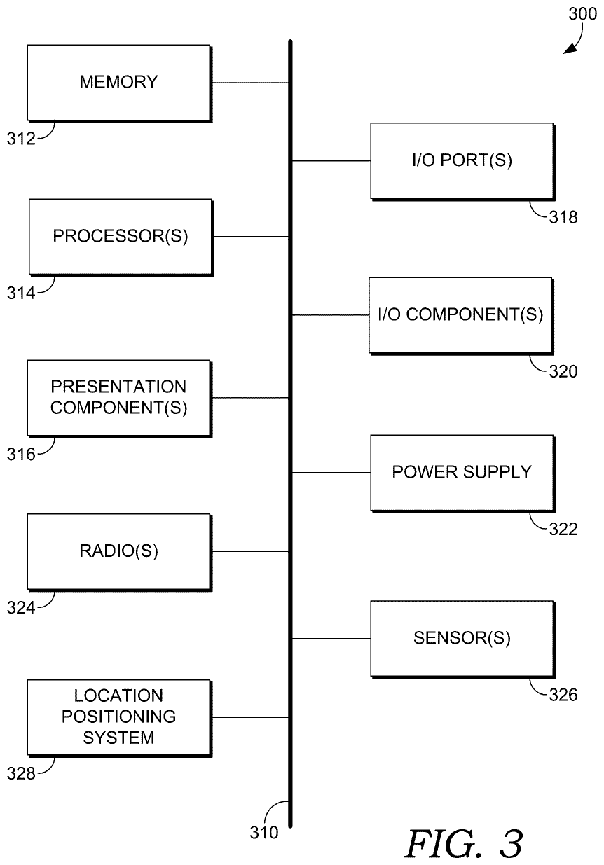

“Computer storage media” may include, without limitation, volatile and non-volatile media, as well as removable and non-removable media, implemented in any method or technology for the storage of information, such as computer-readable instructions, data structures, program modules, or other data. In this regard, computer storage media may include, but is not limited to, RAM, ROM, Electrically Erasable Programmable Read-Only Memory (EEPROM), flash memory or other memory technology, CD-ROM, DVD, holographic media, other optical disk storage, magnetic cassettes, magnetic tape, magnetic disk storage or other magnetic storage device, or any other medium that can be used to store the desired information and which may be accessed by the computing device 300 shown in FIG. 3. These technologies can store data momentarily, temporarily, or permanently.

“Communication media” may include, without limitation, computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner so as to encode information in the signal. By way of example, and not limitation, communication media includes wired media such as a wired network or direct-wired connection and wireless media such as acoustic, radio frequency (RF), infrared, and other wireless media. Combinations of any of the above may also be included within the scope of computer-readable media.

“Network” refers to a network comprised of wireless and wired components that provide wireless communications service coverage, for example, to one or more user devices. For example, the network may include one or more, or a plurality of, wireless networks, hardwired networks, telecommunications networks, peer-to-peer networks, distributed networks, and/or any combination thereof. The network may comprise one or more access points, one or more cell sites (i.e., managed by an access point), one or more structures such as cell towers (i.e., having an antenna) associated with each access point and/or cell site, a gateway, a backhaul data center, a server that connects two or more access points, a database, a power supply, sensors, and other components not discussed herein, in various aspects. Examples of a network include a telecommunications network (e.g., 3G, 4G, 5G, CDMA, CDMA 1XA, GPRS, EVDO, TDMA, GSM, LTE, and/or LTE Advanced) and/or a satellite network (e.g., Low Earth Orbit [LEO], Medium Earth Orbit [MEO], or geostationary). Additional examples of a network include a wide area network (WAN), a local area network (LAN), a metropolitan area network (MAN), a wide area local network (WLAN), a personal area network (PAN), a campus-wide network (CAN), a storage area network (SAN), a virtual private network (VPN), an enterprise private network (EPN), a home area network (HAN), a Wi-Fi network, a Worldwide Interoperability for Microwave Access (WiMAX) network, and/or an ad hoc (mesh) network. The network may include or may communicate with a physical location component for determining a geographic location of an item, package, parcel, personnel, vehicle, endpoint location, etc., by leveraging, for example, a Global Positioning System (GPS), Global'naya Navigatsionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity [SOP]).

“Access point” and “base station” are used interchangeably herein to reference hardware, software, devices, or other components for a communications device or structure having an antenna, an antenna array, a radio, a transceiver, and/or a controller. An access point can be deployed terrestrially at or near the Earth's surface, or within the atmosphere, for example, to orbit the Earth. As discussed herein, an access point is a device comprised of hardware and complex software that is deployed in a network so that the access point can control and facilitate, via one or more antennas or antenna arrays, the broadcast, transmission, synchronization, and receipt of wireless signals in order to communicate with, verify, authenticate, and provide wireless communications service coverage to one or more user devices that request to join and/or are connected to the network. Generally, an access point can communicate directly with one or more user devices according to one or more access technologies (e.g., 3G, 4G, LTE, 5G, and mMIMO). An example of an aerospace access point includes a satellite. Examples of a terrestrial access point include a base station, an eNodeB, a gNodeB, a macrocell, a small cell, a microcell, a femtocell, a picocell, and/or a computing device capable of acting as a wireless “hotspot” that enables connectivity to the network. Accordingly, the scale and coverage area of various types of access points are not limited to the examples discussed. Access points may work alone or in concert with one another, locally or remotely.

“Cell site” is generally used herein to refer to a defined wireless communications coverage area (i.e., a geographic area) serviced by an access point or a plurality of neighboring access points working together to provide a single coverage area. Also, it will be understood that one access point may control one cell site/coverage area, or, alternatively, one access point may control multiple cell sites/coverage areas.

“User equipment” (UE), “user device,” “mobile device,” and “wireless communication device” are used interchangeably to refer to a device having hardware and software that is employed by a user in order to send and/or receive electronic signals/communication over one or more networks, whether terrestrial or aerospace. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

“Machine learning model” is generally used herein to refer to a computational algorithm or statistical model that learns patterns and relationships from data to make predictions or decisions without being explicitly programmed to do so. The model is designed to automatically improve its performance over time as the model is exposed to additional data. These models can be trained on various types of data, such as images, text, numerical values, or any combination of these. The model can be used to make predictions or classify new, unseen data. Examples of machine learning models include artificial intelligence (AI)-based models, linear regression, decision trees, support vector machines, neural networks, more complex deep learning architectures, a hybrid model, and/or any combination thereof.

The terms “radio,” “controller,” “antenna,” and “antenna array” are used interchangeably herein to refer to one or more software and hardware components that facilitate sending and receiving wireless radio frequency signals, for example, based on instructions from a base station. A radio may be used to initiate and generate information that is then sent out through the antenna array, for example, where the radio and antenna array may be connected by one or more physical paths. Generally, an antenna array comprises a plurality of individual antenna elements. The antennas discussed herein may be dipole antennas having a length, for example, of ¼, ½, 1, or 1½ wavelengths. The antennas may be monopole, loop, parabolic, traveling-wave, aperture, Yagi-Uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that sequential or relative terms such as “first,” “second,” and “third” are used herein for the purposes of clarity in distinguishing between elements or features, but the terms are not used herein to import, imply, or otherwise limit the relevance, importance, quantity, technological functions, physical or temporal sequence, physical or temporal order, and/or operations of any element or feature unless specifically and explicitly stated as such.

### Overview

As discussed hereinafter, aspects involve a device having an embedded Subscriber Identity Module (eSIM), wherein the device can leverage sensors, networks, and machine learning (e.g., artificial intelligence [AI]) to identify a deviation from a pattern based on a qualifying event. Using environmental data captured by a sensor of the device and a near-real-time machine learning model event detection, the device may provide timely alerts and information to a user based on user preference. In particular, the device provides alerts and information using one or more modalities that are specific to the user preference associated with the eSIM, and, for example, accommodate a user's temporary or permanent impairment or disability. Additionally or alternatively, the device can alert a user of the device of a hazardous condition or event by communicating the alert in a mode that is sensible to the user, based on the user preferences that defines the accessibility setting that is specific to the physical characteristics of the user, and such modes may include audible, haptic, or optical presentations of the alert. For example, where a user preference indicates that a user has a hearing impairment, the device provides alerts and information using haptic feedback and visually presented information for the user, wherein the alerts and information correspond to the event(s) detected via the near real-time sensor data and the machine learning model event detection. For brevity, the device having an eSIM is referred to herein simply as the “device.”

For example, the device may capture sensor and/or location data in near real-time using optical sensors, real-time location information, and the like. As used hereinafter, “data” and “sensor data” generally refers to sensor-captured data of the device's environment or surroundings, of raw data from the device, a timestamp, location data associated with or captured by the device, and/or any combination thereof, for example. In some instances, the device may capture sensor data that is relevant to, related to, specific to, and/or customized for a physical characteristic of a user of the device. In one instance, the device may be user-wearable “smart glasses” that capture visual sensor data (e.g., image data, video data, LiDAR data, RADAR data, infrared imagery, etc.) for a vision-impaired user wearing the device. In various instances, the device may be any device that is capable of capturing any type of sensor data (e.g., visual data, olfactory data, audible data, haptic data, etc.) and location data in near real-time. The sensors may be integrated by the device, may be physically proximate to the device so as to communicate with the in-range device, and/or any combination thereof.

In some instances, the device may identify a pattern in the data captured using a machine learning model, such as an AI-based model. For example, a machine learning model, such as a neural network, can be used by the device to identify a pattern in the data captured, based on the data (e.g., sensor-captured data, location data, etc.). The “pattern” that is learned by the machine learning model generally corresponds to the daily activities of a user of the device (e.g., a behavior pattern). The machine learning model is hosted, stored, and/or otherwise maintained by a server, a network, the device, and/or the “cloud” in various instances.

By subsequently monitoring additional data captured in near real-time by the device, the machine learning model may detect a deviation in the additional data from the pattern previously identified by the machine learning model. The machine learning model may periodically, intermittently, or continuously monitor data regarding the environment surrounding the device to form and refine the originally identified or previously “learned” pattern. When a deviation from said pattern is detected in the additional and/or newly acquired data, the machine learning model may determine whether the deviation meets or exceeds a threshold. The machine learning model determines whether the deviation meets or exceeds a threshold by analyzing the surrounding environment (e.g., using the additional data and/or ongoing data captured in near real-time at the device) to determine what may have caused the deviation in the pattern. For example, the machine learning model may determine whether the weather caused the deviation in the pattern, such as heavy rain or snow affecting the daily commute of a user of the device. Accordingly, the machine learning model determines whether the deviation from the pattern meets or exceeds a threshold.

When the deviation is determined to exceed the threshold, the device initiates an action. In some examples, initiating an action includes referencing a user preference that is associated with the device. In some instances, the user preferences define an accessibility setting that is specific to a physical characteristic of the user. For instance, the physical characteristics of a user may include an impairment of a physical sense of the user (e.g., a physical impairment, such as loss of sight, hearing, smell, feeling, etc.), and the accessibility setting can include a configuration for the device that accounts for the impairment. Initiating an action when the deviation from the pattern exceeds a threshold can include communicating an alert to the user in a mode that is sensible to the user. For example, if the machine learning model cannot identify an acceptable reason for the deviation, but rather determines that the deviation could indicate that the user of the device may be in danger, the device may initiate an action, such as notifying the user via haptic feedback—and/or communicating via a server to the local authorities (e.g., via an external system)—that the user may be in danger due to the deviation (e.g., the change in the behavior pattern). The machine learning model identifies an event associated with the deviation (e.g., a potentially dangerous event), and any alert communicated by the device may identify the event.

Accordingly, the device can intelligently determine how (e.g., what wireless network to use that is in-range; and what location and/or sensor data to be included in the notification[s]) and when (e.g., periodicity or frequency, such as, for instance, one notification per day) to identify a deviation from a pattern of normal activity; initiate an action based on that deviation; and communicate an alert about the action to notify a user that the deviation might be associated with a hazardous condition or event. Furthermore, the device can alert a user of the device of the hazardous condition or event by communicating the alert in a mode that is sensible to (i.e., can be physically sensed by) the user, based on the user preferences that define the accessibility setting that is specific to the physical characteristics of the user. Such modes may include audible, haptic, or optical presentations of the alert.

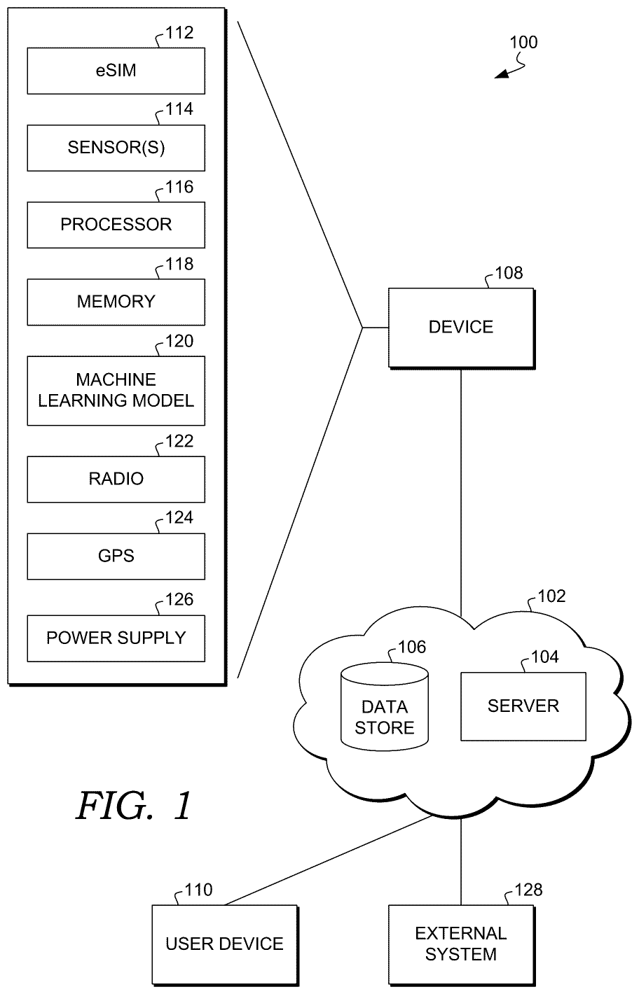

FIG. 1 depicts an example of a network environment 100 in accordance with one or more aspects. The network environment 100 of FIG. 1 includes a network 102, a cloud-based platform 104 (e.g., server), a database 106, a device 108, a user device 110, and an external system 128. In aspects, the network 102 is a telecommunications network having a plurality of access points that provide service to a plurality of user devices, such as the device 108 and the user device 110. The cloud-based platform 104 and the database 106 operate within the network 102, and as further discussed, can provide services to users via the device 108 and the user device 110. The cloud-based platform 104 may be a virtual server that operates in a cloud computing environment, and which is supported by individual server(s) in data centers. Although a cloud-based platform 104 is discussed herein, it will be understood that platforms that are partially cloud-based or are not cloud-based may be utilized and leveraged, whether alone or in connection with a cloud-based server, to perform aspects discussed herein. The database 106 can operate as cloud-based storage that supports the cloud-based platform 104 in a cloud computing environment as shown, or it may instead be partially cloud-based or not cloud-based, in various aspects.

The device 108 of FIG. 1 is a type of user device having an eSIM 112, sensor(s) 114, a processor 116, a memory 118, a machine learning model 120, a radio 122, a location service module such as a global positioning system (GPS) 124, and a power supply 126.

The eSIM 112 operates as a non-physical SIM card that is digitally embedded into an embedded Universal Integrated Circuit Card (eUICC) chip, for example, in the device that identifies the device when connected to various networks, such as a 5G or a 6G network. In general, the eSIM is a digital replacement of a physical SIM card such that a user can immediately utilize a new device and/or switch over to a new Mobile Network Operator (MNO) without having to remove or replace a physical SIM card.

The sensor(s) 114 may include one or more sensors of the same or different kinds. Examples of sensors include a gyroscope, an accelerometer (e.g., for detecting and measuring movement of the device 108), an optical sensor (e.g., for detecting and measuring light), a camera (e.g., for capturing images), an olfactory sensor or electronic nose (e.g., for detecting and identifying smells), a microphone (e.g., for detecting and measuring sound), a temperature sensor, an atmospheric pressure sensor, a humidity or water sensor, the like, and/or any combination thereof.

The machine learning model 120 may be any type or kind of machine learning based data model trained or trainable using one or more machine learning algorithms, and may further utilize AI techniques (e.g., a neural network). Such models may include supervised learning, unsupervised learning, or a hybrid thereof. Examples of machine learning data model types include hierarchical, network, relational, dimensional, object-oriented and entity-relationship types. Examples of machine learning algorithms include regression algorithms and/or classification algorithms. Additional examples of machine learning algorithms include simple or multiple linear regression, logistical regression, polynomial regression, lasso regression, Bayesian linear regression, K-Nearest neighbors, Random Forest, Decision Tree, Naïve Bayes, and the like. Although shown as operating on the device 108 in FIG. 1, it will be understood that the machine learning model 120 may be stored, hosted, and/or “run” on the cloud-based platform 104, or in a hybrid and/or distributed manner across one or more devices.

The processor 116 may be a microcontroller unit and/or a microprocessor unit configured to operate and control hardware components of the device 108, in various aspects. The memory 118 may be physical memory for storing data and computer-readable instructions for execution and implementation via the processor 116, and/or any other components of the device 108. The radio 122 may be configured to send and receive wireless communications using multiple modalities, connections, and/or networks, concurrently or non-concurrently, including telecommunications, Wi-Fi, short-range wireless (e.g., Bluetooth®), Near-Field Communication (NFC), and the like using one or more antennas. The location service module, shown in FIG. 1 as the GPS 124, is a hardware component that utilizes measurements to determine the location, direction of travel, and/or speed (e.g., velocity) of travel of the device 108 in real-time or near real-time using a satellite network (not shown) that is accessible using a satellite (not shown). The power supply 126 stores and provides energy to the device 108 and its components. The power supply 126 may be a battery, in some aspects.

In various aspects, the device 108 includes additional features and components, such as a speaker, a light or light-emitting diode, a microphone, a modem, a low-dropout regulator (LDO), and/or the like. In some examples, the device 108 operates for tracking and data collection purposes and may not be configured to handle telephone calls and/or messaging services such as Short Message/Messaging Service (SMS). In other examples, the device 108 operates for tracking and data collection purposes, but the device 108 may also be configured to handle telephone calls and/or messaging services. For instance, the device 108 may send messages (e.g., communicating a notification) to the cloud-based platform 104 to send an alert to the device 108, the user device 110, and/or the external system 128.

The device 108 may take on many shapes and sizes. The form and design of the device 108 may depend on the physical characteristics of a user. In some instances, the device 108 may be configured to act as a type of aid for a specific impairment of a user. For instance, the device may be user-wearable “smart glasses” that capture visual sensor data (e.g., image data, video data, LiDAR data, RADAR data, infrared imagery, etc.) for a vision-impaired user wearing the device, headphones for a hearing-impaired user wearing the device, a headset, necklaces, clips, “smart watch,” and or any other portable device that can be worn or carried by a user. In some instances, the device 108 may be integrated within and/or attached to the user device 110 (though shown as separate in FIG. 1 for simplicity), or it may operate as a wholly separate device. In various instances, the device 108 may itself be a user device, such as a smartphone, a laptop, or tablet. Based on the dimensions, the device 108 can be physically attached to or carried along with a person.

It should also be understood that the network environment 100 shown in FIG. 1 is only one example of a suitable network environment 100, and this example has been simplified for ease of discussion. Accordingly, other components not shown may also be included within the environment, and one or more of the shown components may be omitted, in various embodiments. Each of the components of FIG. 1 may be implemented using any type or number. The components may communicate with each other directly or, for example, indirectly via a network, including one or more of a telecommunication network, a local area network (LAN), a wide area network (WAN), and/or a peer-to-peer-network. Such networking environments may include campus-wide or enterprise-wide computer networks, intranets, and the Internet. It should be understood that any number of components shown in FIG. 1 may be employed within the network environment 100 within the scope of the present disclosure. Each may be implemented via a single device or multiple devices cooperating in a distributed environment.

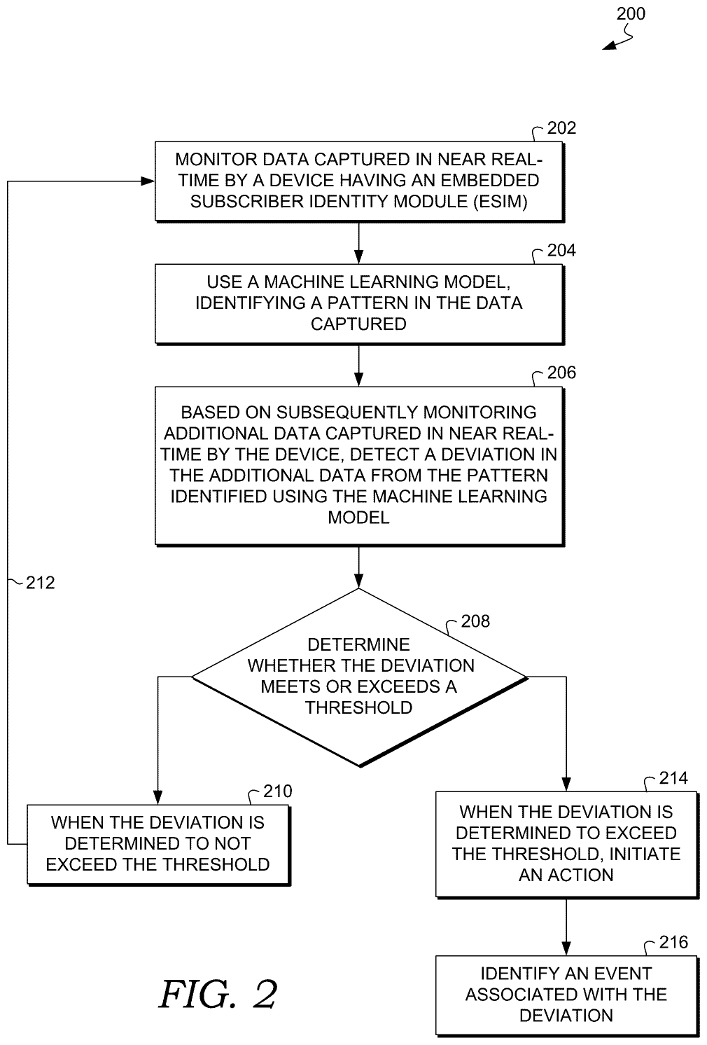

FIG. 2 depicts a flowchart for an example method 200 to be performed in accordance with aspects herein, such as through components shown in FIG. 1. The method 200 may be a computer-implemented method, in various aspects, for example, using non-transitory computer-readable storage medium having computer-readable program code portions embodied therein that are used to implement the method 200. For example, the computer-readable program code portions may include one or more executable portions configured to perform the method 200, in aspects.

Data captured in near real-time by the device is monitored by the machine learning model, whether the monitoring is initiated by user input to the device, initiated by user input to another proximate device (e.g., a smartphone that is paired with the device; a user device, etc.) that can send communications to the device, initiated automatically by the device based on sensor data (e.g., captured by sensor[s]), and/or initiated automatically based on a communication sent to the device 108 by the proximate device. As such, one or more actions, whether external to the device and/or performed actively or passively by the device, may be used to initiate or trigger the method 200.

The device, at block 202, captures data in near real-time. For example, using sensor(s), the device may capture sensor data associated with the surrounding environment (e.g., environmental data), such as visual data, olfactory data, audible data, haptic data, temporal data, temperature data, atmospheric pressure data, humidity data, and any other type of data that can be associated with a surrounding environment (e.g., environmental data). Sensor data may include environmental data such as, for example, measurements of ambient temperature, sounds, visuals, smells, moisture, altitude, and the like. In some instances, the device may capture sensor data that is relevant to, related to, specific to, and/or customized for a physical characteristic of a user of the device. The sensor(s) may be integrated by the device, may be physically proximate to the device so as to communicate with the in-range device, and/or any combination thereof.

Additionally or alternatively, using the GPS, the device may capture location data in near real-time. Location data may include, for example, GPS coordinates, signal strength measurements, and the like, of the device itself, the proximate device, and/or such locations relative to static destinations (e.g., a church, a particular business, a subway station, etc.). Although GPS systems are discussed herein, other technologies are contemplated and considered within the scope of this disclosure. For example, the device may determine its own location using the location of an in-range mobile device as a proxy, which the device can communicate using Bluetooth®.

In some aspects, the device may gather data from a user device. For example, the device may gather data associated with a user's telecommunication records, such as data associated with a user's phone calls, text messages, emails, calendar, photos, application usage, and any other type of data that can be stored on the user device. In aspects, a user of the device can manually approve or restrict the type of data that may be captured by the device.

In some examples, sensor and/or location data is continuously or near-continuously, periodically (e.g., fixed or dynamic intervals), or intermittently (e.g., when triggered by sensor[s] or input) captured and is monitored by the device for event detection, as further discussed herein. For example, sensor(s) and GPS may capture data associated with the surrounding environment and the location, respectively, of the device, and the machine learning model of the device may monitor the captured data, updating the captured data with more captured data as the surrounding environment and location changes over time. In some instances, the device may use its eSIM capabilities to collect and transmit (e.g., to a server, such as the cloud-based platform) the captured data (e.g., environmental data and location data) within high-activity regions (e.g., outdoor classified areas) with higher bandwidth. High-activity regions are outdoor areas that are often associated with dense foot traffic (e.g., significantly populated with people), and these areas are often classified as requiring higher bandwidth.

At block 204, the device may use the machine learning model 120 to identify a pattern in the data captured. The machine learning model 120 can be located on the device 108, on the cloud-based platform 104, on another type of server, or any other suitable medium. In aspects, the machine learning model 120 can utilize the data captured to identify a pattern associated with a user of the device 108. For example, through near real-time analysis of the data as that data is collected, the machine learning model 120 may determine that a user of the device 108 follows a daily routine of going on a walk around the local park (e.g., within a high-activity geographic region or a predetermined geofence, based on the speed of movement of the device 108 and GPS tracking) from approximately 6:00 AM to 7:00 AM local time on particular days of the week, which includes an interruption of locomotion for approximately five minutes at a location that corresponds to a coffee shop, and that the walk does not occur during specific weather patterns (e.g., forecasted rain or snow within the geofence reduces the likelihood of the observed movement) and/or during particular months of the year (e.g., related to seasonality or temperature). In some examples, the pattern may be represented using a graphic or image generated by the device 108, such as a graph (e.g., bar chart, line chart, etc.). Any quantity of simple and/or complex patterns of movement, transportation, timing, frequency, locations, and/or other behaviors may be learned by the machine learning model 120. Once learned, predictions of future behavior may be made by the machine learning model 120, based on the one or more patterns it has identified and learned as representative of the device 108, and by proxy, of the user of that device 108. Subsequently, additional sensor and/or location data is captured and monitored via the device 108 to refine the identifier pattern(s) and for event detection, as discussed below.

At block 206, based on monitoring additional data captured in near real-time by the device 108, the machine learning model 120 may detect a deviation in the additional data from the pattern previously identified by the machine learning model 120. In some examples, the machine learning model 120 may periodically, intermittently, or continuously monitor the environment surrounding the device 108 and capture additional data. Using the additional data, the device 108 and/or the machine learning model 120 may form and refine the originally identified or previously “learned” pattern. As such, the machine learning model 120 may update the originally or previously identified pattern using the additional data to reflect deviations (e.g., changes) that are associated with the baseline pattern of a user of the device 108 and which the machine learning model 120 determines are expected to reoccur, and/or are confirmed to reoccur based on additional data captured over a period of time. For example, if the user in the previous example starts to walk in the local park from 7:00 AM to 8:00 AM local time instead of 6:00 AM to 7:00 AM, and/or the walk occurs on Mondays, Wednesdays, and Fridays instead of daily, the machine learning model 120 may identify that this detected deviation in the pattern is reoccurring and may update the pattern accordingly (e.g., store the pattern in data store 106). Accordingly, the machine learning model 120 may identify baseline pattern(s) when sufficient data is collected (e.g., when a threshold number of data points are collected over a period of time), and that baseline pattern(s) may be automatically changed or updated as more data is collected over longer periods of time and observation, meaning that the machine learning model 120 may continue to identify new patterns as additional data is captured.

At block 208, when a deviation from said pattern is detected in the additional and/or newly acquired data, the machine learning model 120 may determine whether the deviation meets or exceeds a threshold. A threshold in machine learning models serves as a critical decision point, typically applied to prediction probabilities to determine class labels (e.g., in binary classification tasks). By setting a threshold, achieving or surpassing that threshold indicates one class (e.g., an alert is warranted), while not achieving the threshold indicates a different class (e.g., an alert is not warranted). The machine learning model 120 determines whether the deviation meets or exceeds a threshold by analyzing the device's surrounding environment (e.g., using the additional data and/or ongoing data captured in near real-time at the device) to determine what may have caused the deviation in the pattern. As such, the threshold may be a contextual threshold in some instances, or for specific patterns. For example, the machine learning model 120 may determine whether the weather caused the deviation in the pattern, such as heavy rain or snow affecting the daily commute of a user of the device. Here, the deviation likely will not be determined (e.g., in binary classification) to have met or surpassed a predefined threshold. Accordingly, the machine learning model 120 determines whether the deviation from the pattern meets or exceeds a threshold.

In aspects, a substantial deviation (e.g., based on a percentage difference) from the pattern could warrant action. For example, a deviation that exceeds a predetermined threshold that defines a value (e.g., an upper limit, a lower limit, a range, a single value, a percentage, flanking “buffer” ranges around a threshold value, and the like) may warrant sending an alert to a user of the device 108 that an event is detected that deviates from the baseline pattern in a manner that exceeds a threshold. As such, the threshold may be a numerical threshold in some instances, or for specific patterns. It will be understood that each of several particular baseline patterns may have their own tailored threshold(s) for event detection.

For example, a specific user of the device 108 may make a business call on a proximate device every weekday at 9:00 AM local time, as identified as a baseline pattern for user calls made on the proximate device. If that specific user does not make a business call at 9:00 AM on a weekday, the machine learning model 120 may determine whether the deviation should result in communicating an alert, and/or may analyze additional sensor data, location data, and/or proximate device data to try to identify the source or origin that caused or resulted in the deviation from the baseline pattern. In this example, an examination of the proximate device data may show that another event is currently slotted at 9:00 AM for that date in the user's calendar. Based on the purposeful nature of calendar events, the machine learning model 120 may determine that the deviation does not meet or exceed a contextual threshold warranting an action. However, in a different scenario, where the same analysis of the data does not lead to a sufficient reasoning for the deviation, then the contextual threshold is met, resulting in a determination that sending an alert to the user informing the user that they may want to make the business call may be warranted or beneficial. Accordingly, whether an action is initiated is determined by whether the deviation meets or exceeds a given threshold. Numerical and contextual thresholds may be automatically learned by the model, may be predetermined, and/or may be input/customized by a user through the user settings of the device 108.

At block 210, when the deviation is determined to not exceed the threshold, the machine learning model returns to monitoring the data that is captured in near real-time. For instance, as indicated by arrow 212, the machine learning model may monitor the (new or additional) data that is subsequently captured in near real-time by the sensor(s) and/or GPS of the device, and the machine learning model may continue to identify and refine the baseline pattern. Thus, because a threshold has not been met or exceeded, further action is not warranted.

At block 214, when the machine learning model determines that a deviation exceeds the threshold, the machine learning model initiates an action. In some instances, the action may include automatically activating a sensor of the device to measure environmental data associated with the identified deviation. In some aspects, the action initiated comprises automatically referencing a user preference that is associated with the device. In some examples, the user preference may define an accessibility setting that is specific to a physical characteristic of the user. For example, the physical characteristics of a user may include an impairment of a physical sense of the user (e.g., a physical impairment, such as loss of sight, hearing, smell, feeling, etc.), and the accessibility setting can include a configuration for the device that accounts for the impairment. By referring to the user preference that defines an accessibility setting that is specific to a user's physical impairment, the device, via the eSIM, may more effectively initiate an action.

At block 216, the machine learning model may identify an event that is associated with the deviation. For example, the event that is detected and/or identified based on the additional data captured in near real-time could be a hazardous condition in the surrounding environment at the physical location of the device. As such, the event may be an underlying or predicted cause or origin that is related to and/or relevant contextually to the deviation from the baseline pattern that was detected and determined to exceed the threshold.

Based on identifying an event, one or more actions may be initiated that are responsive to the event and the deviation. In aspects, such an action may include communicating information about the event to a server (e.g., cloud-based platform 104 in FIG. 1), and the server may communicate the event to the user of the device 108 using a proximate device or other mechanism. For example, the action may comprise communicating an alert that identifies the event to the device itself, the user device, another proximate device or electronic address, or any combination thereof. When an event is identified as or is determined to correspond to a hazard that threatens the health, safety, and/or well-being of the user via the model, the action that is initiated may include a preventative measure that is specifically responsive to addressing the hazard and/or evading the hazard. As such, actions may include alerts that are provided in near real-time with detection of the deviation to the user via the device or another device.

In aspects, based on the user preference that defines an accessibility setting that is specific to the physical characteristics of the user, the action may be an alert. The alert may be communicated in a mode (e.g., a way or manner in which something occurs or is experienced, expressed, or done) that is sensible (e.g., capable of being perceived by the senses) to the particular user. The accessibility setting may define or specify a configuration for the device 108 that accounts for any physical impairment and ensures that the alert may be communicated to the user in a mode that is capable of informing the user of the event and/or the deviation. For example, the mode may be an audible, haptic, and/or optical presentation of the alert. As such, the alert may be communicated, for example, via push notification (e.g., Apple Push Notification Service [APNS]), a vibration, audio warnings, and/or video warnings. A user of the device 108 can determine the desired or preferred mode of communicating the alert with the accessibility setting.

In one example, a user may have a temporary or permanent vision impairment. In this case, an audible alert may be a proper mode of communicating the alert. For example, a user with a vision impairment may not be able to see that there is an accident ahead of them. In this example, the device may be able to determine that the accident has occurred (e.g., by analyzing environmental data obtained from sensor(s), such as cameras), and the device may communicate an alert to the user to inform the user about the accident. For instance, the user may get an audible warning, such as a verbal warning broadcasted from the device (e.g., via radio 122 of FIG. 1) or the speakers of the user device, which may alert the user to go in a different direction to avoid the accident, because the accident may have been determined to be a deviation from the baseline pattern that exceeds a threshold. Accordingly, the device 108 may act as a visual guide that may inform the user of navigation issues and near real-time barriers and communicate potential and actual deviations to the user.

In another example, a user may have a temporary or permanent hearing impairment. Here, a haptic alert may be a proper mode to communicate an alert to the user. For example, a user with a hearing impairment may not hear a car honking or a train approaching. In this example, the device may be able to determine that a car is hooking or a train is approaching (e.g., by using environmental data obtained from sensor(s), such as microphones and cameras), and the device 108 may communicate an alert to the user to inform the user about the potential hazards. For instance, the user may get a haptic warning, such as a vibration on the device or the user device, which alerts the user of the potential hazards. Accordingly, the device may act as synthetic ears for a user with a hearing impairment.

In yet another example, the user may have a temporary or permanent smelling impairment (e.g., congenital anosmia). In this example, a mode determined based on the user's preference is the mode that will be used to communicate an alert to the user. For example, a user who cannot smell may not be able to sense that there is a gas leak in their home. However, the device may be able to determine that there is a gas leak using a sensor or a proximately located sensor, and the device may communicate an alert to the user to inform the user about the gas leak. Accordingly, the device may act as an electronic nose that may inform the user of smells associated with potentially dangerous hazards, which may be considered a threshold deviation from the baseline pattern. In further aspects, an alert of the gas leak may be communicated to an external system or third party, such as local authorities or a utility company.

In some aspects, a user of the device may provide an input that acknowledges the alert and causes the device to communicate the acknowledgement over any available wireless network. If the user does not react to the alert (e.g., does not acknowledge the alert), the alert may be communicated to the next level, sending a second alert to the user or informing the local authorities via the external system that the user could be in potential danger. In aspects, the external system is any type of network or server that can facilitate communicating an alert to a third party. In some examples, contacting the local authorities in addition to the user may be an initial communication of an alert based on the deviation and/or event detected. For example, sensor(s) of the device may capture data that the machine learning model identifies as a burglary or home invasion (e.g., or an attempted burglary), based on a deviation. The device may send information to an external system as well as the user. In this example, the server may identify a particular authority to be contacted based on the event identified and communicate a notification (e.g., an alert) to that particular authority. Accordingly, the device may operate to inform third parties of an identified event, which is a feature that can be customized in the accessibility setting of the device 108.

Overall, when the device determines that a deviation exceeds the threshold, initiates an action, and identifies an event associated with the action, the device may provide output that communicates an alert to a user regarding an event, the action, and/or a hazard that corresponds to the event. The particular hazard may correspond to an identified deviation from the pattern identified by the machine learning model. The output may be at least one of a visual, audible, and/or haptic output. In response to identifying the hazard, the device may automatically communicate an alert to the user-in a mode that is sensible to the user-over the wireless network that is available. For example, the output may include light (e.g., flashing frequency, color, or brightness changes), sound (e.g., frequency of a tone emitted in pulses, changing the tone or pitch of a tone being emitted, etc.), and/or vibration (e.g., frequency of a vibration, vibration pattern, strength of vibration changes, etc.) to signal to the user that there may be a nearby hazard. Furthermore, a user may provide an input that acknowledges the alert and causes the device to communicate an acknowledgement of the alert over an available wireless network. As such, the device may capture environmental data associated with the surrounding environment of a user and communicate the data to a server, which will quickly analyze the data and send an alert to the user to communicate to the user that there may be a hazard nearby and/or to communicate to the local authorities that the person could be in danger.

Turning to FIG. 3, an example computing device 300 is shown that is suitable for use in implementations of the disclosure. Computing device 300 is but one example of a suitable computing environment and is not intended to suggest any limitation as to the scope of use or functionality of the disclosure, and nor should computing device 300 be interpreted as having any dependency or requirement relating to any one or combination of components illustrated.

The implementations of the present disclosure may be described in the general context of computer code or machine-useable instructions, including computer-executable instructions such as program components being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 3, computing device 300 includes bus 310 that directly or indirectly couples with the following devices: memory 312, one or more processors 314, one or more presentation components 316, input/output (I/O) ports 318, I/O components 320, and power supply 322. Bus 310 represents what may be one or more buses (such as an address bus, data bus, or combination thereof). Although the devices of FIG. 3 are shown with lines for the sake of clarity, in reality, delineating various components is not so clear, and metaphorically, the lines would more accurately be grey and fuzzy. For example, one may consider a presentation component such as a display device to be one of I/O components 320. Also, processors, such as one or more processors 314, have memory. Distinction is not made between such categories as “workstation,” “server,” “laptop,” “handheld device,” etc., as all are contemplated within the scope of FIG. 3 and refer to “computer” or “computing device.”

Computing device 300 typically includes a variety of computer-readable media. Computer-readable media can be any available media that can be accessed by computing device 300 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, digital versatile disks (DVDs) or other optical disk storage, magnetic cassettes, magnetic tape, and magnetic disk storage or other magnetic storage devices. Computer storage media does not comprise a propagated data signal.

Communication media typically embodies computer-readable instructions, data structures, program modules or other data in a modulated data signal (such as a carrier wave or other transport mechanism), and includes any information delivery media. The term “modulated data signal” indicates a signal that has one or more of its characteristics set or changed in such a manner so as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 312 includes computer storage media in the form of volatile and/or non-volatile memory. Memory 312 may be removable, non-removable, or a combination thereof. Examples of memory include solid-state memory, hard drives, optical disc drives, etc. Computing device 300 includes one or more processors 314, which read data from various entities such as bus 310, memory 312, or I/O components 320. One or more presentation components 316 present data indications to a person or other device. Examples of one or more presentation components 316 include a display device, speaker, printing component, vibrating component, etc. I/O ports 318 allow computing device 300 to be logically coupled to other devices including I/O components 320, some of which may be built into computing device 300. Illustrative I/O components 320 include a microphone, joystick, game pad, satellite dish, scanner, printer, wireless device, etc.

Radio 324 represents a radio that facilitates communication with a wireless telecommunications network. Illustrative wireless telecommunications technologies include CDMA, GPRS, TDMA, GSM, and the like. Radio 324 might additionally or alternatively facilitate other types of wireless communications including Wi-Fi, WiMAX, LTE, or other VoIP communications. As can be appreciated, in various aspects the radio 324 can be configured to support multiple technologies, and/or multiple radios can be utilized to support multiple technologies. A wireless telecommunications network might include an array of devices, which are not shown so as to not obscure more relevant aspects of the disclosure. Components such as a base station, a communications tower, or even access points (as well as other components) can provide wireless connectivity in some aspects.

Sensor(s) 326 can include one or more sensors of the same or different kinds, such as a gyroscope, an accelerometer (e.g., for detecting and measuring movement of the device 108 including speed, acceleration, deceleration, change of direction, etc.), an optical sensor (e.g., for detecting and measuring light), a temperature sensor, an atmospheric pressure sensor, a humidity or water sensor, a vibration sensor, impact sensor, the like, and/or any combination thereof. As can be appreciated, in various aspects the sensor(s) 326 can be configured to support multiple technologies, and/or multiple sensors can be utilized to support multiple technologies. A wireless telecommunications network might include an array of devices, which are not shown so as to not obscure more relevant aspects of the disclosure. Components such as a base station, a communications tower, or even access points (as well as other components) can provide wireless connectivity in some aspects.

Location positioning system 328 is a type of GPS that can determine the location of an object. For example, location positioning system 328 can comprise GPS coordinates, signal strength measurements, and/or the like. As can be appreciated, in various aspects the location positioning system 328 can be configured to support multiple technologies, and/or multiple location positioning systems can be utilized to support multiple technologies. A wireless telecommunications network might include an array of devices, which are not shown so as to not obscure more relevant aspects of the disclosure. Components such as a base station, a communications tower, or even access points (as well as other components) can provide wireless connectivity in some aspects.

Many different arrangements of the various components depicted, as well as components not shown, are possible without departing from the scope of the claims below. Aspects of our technology have been described with the intent of being illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A computerized method comprising:
monitoring data captured in near real-time by a device having an embedded Subscriber Identity Module (eSIM);
using a machine learning model, identifying a pattern in the data captured;
based on subsequently monitoring additional data captured in near real-time by the device, detecting a deviation in the additional data from the pattern identified using the machine learning model;
determining whether the deviation meets or exceeds a threshold;
when the deviation is determined to exceed the threshold, initiating an action; and
identifying an event associated with the deviation.

2. The computerized method of claim 1, wherein the action initiated comprises automatically referencing a user preference that is associated with the eSIM, wherein the user preference defines an accessibility setting that is specific to a physical characteristic of a user.

3. The computerized method of claim 2, further comprising:
communicating an alert to the device associated with the eSIM, wherein the alert identifies the event.

4. The computerized method of claim 3, wherein the alert is communicated in a mode that is sensible to the user, based on the user preference that defines the accessibility setting that is specific to the physical characteristics of the user.

5. The computerized method of claim 2, wherein the physical characteristic is associated with an impairment of a physical sense of the user, and wherein the accessibility setting comprises a configuration for the device that accounts for the impairment.

6. The computerized method of claim 4, wherein the mode comprises an audible, haptic, or optical presentation of the alert.

7. The computerized method of claim 1, wherein the action comprises a preventative action that is responsive to the deviation identified, and wherein the event comprises a hazard based on the additional data captured in near real-time by the device.

8. The computerized method of claim 1, wherein the action initiated comprises automatically activating a sensor of the device, and wherein the sensor measures environmental data associated with the deviation identified, as corresponding to the event.

9. The computerized method of claim 1, wherein initiating the action further comprises:
identifying a particular authority based on the event identified; and
communicating a notification of the event to the particular authority.

10. One or more non-transitory computer-readable media storing instructions that when executed via one or more processors perform a computerized method, the media comprising:
monitor data captured in near real-time by a device having an embedded Subscriber Identity Module (eSIM);
using a machine learning model, identify a pattern in the data captured;
based on subsequently monitoring additional data captured in near real-time by the device, detect a deviation in the additional data from the pattern identified using the machine learning model;
determine whether the deviation meets or exceeds a threshold;
when the deviation is determined to exceed the threshold, initiate an action; and
identify an event associated with the deviation.

11. The media of claim 10, further comprising via the one or more processors:
automatically reference, as the action initiated, a user preference that is associated with the eSIM, wherein the user preference defines an accessibility setting that is specific to a physical characteristic of the user.

12. The media of claim 11, further comprising via the one or more processors:
communicate an alert to the device associated with the eSIM, wherein the alert identifies the event.

13. The media of claim 12, further comprising via the one or more processors:
communicate the alert in a mode that is sensible to the user, based on the user preference that defines the accessibility setting that is specific to the physical characteristic of the user.

14. The media of claim 11, further comprising via the one or more processors:
associate the physical characteristic with an impairment of a physical sense of the user, wherein the accessibility setting comprises a configuration for the device that accounts for the impairment.

15. The media of claim 14, further comprising via the one or more processors:
present the alert in an audible, haptic, or optical mode.

16. The media of claim 10, further comprising via the one or more processors:
cause the action initiated to be a preventative action that is responsive to the deviation identified, wherein the event comprises a hazard based on the additional data captured in near real-time by the device.

17. The media of claim 10, further comprising via the one or more processors:
cause the action initiated to be an automatic activation of a sensor of the device, wherein the sensor measures environmental data associated with the deviation identified, as corresponding to the event.

18. The media of claim 10, further comprising via the one or more processors:
when the event associated with the deviation is identified as an attempted burglary, determine an authority to inform; and
inform the authority of the event.

19. The media of claim 10, further comprising via the one or more processors:
when the event associated with the deviation is identified as a gas leak, determine an authority to inform; and
inform the authority of the event.

20. A system comprising:
a user device having one or more processors; and
an embedded Subscriber Identity Module (eSIM) operating within a telecommunications network, the eSIM configured to:
receiving as input data captured in near real-time by a device having the eSIM;
using a machine learning model, identifying a pattern in the data captured;
based on subsequently monitoring additional data captured in near real-time by the device, detecting a deviation in the additional data from the pattern identified using the machine learning model;
determining whether the deviation meets or exceeds a threshold;
when the deviation is determined to exceed the threshold, initiating an action;
identifying an event associated with the deviation; and
generating and communicating an alert to the user device.
